(19) United States
(12) Patent Application Publication
(10) Pub. No.: US 2003/0196024 A1
(43) Pub. Date: Oct. 16, 2003

(54) Apparatus and method for a skip-list based cache

(75) Inventor: Shahar Frank, Ramat Hasharon (IL)

Correspondence Address: SUGHRUE MION, PLLC, 2100 PENNSYLVANIA AVENUE, N.W., WASHINGTON, DC, 20037, US

(73) Assignee: EXANET, INC.

(21) Appl. No.: 10/122,183

(22) Filed: Apr. 16, 2002

(51) Int. Cl. G06F 12/08

(52) U.S. Cl. 711/3; 711/118

(57) ABSTRACT

An apparatus and a method for the implementation of a skip-list based cache is shown. While the traditional cache is basically a fixed length line based or fixed size block based structure, resulting in several performance problems for certain application, the skip-list based cache provides for a variable size line or block that enables a higher level of flexibility in the cache usage.

### BACKGROUND OF THE PRESENT INVENTION

1. Technical Field of the Present Invention

The present invention relates generally to the field of cache memory and more specifically to large size cache memories having a varying block size.

2. Description of the Related Art

There will now be provided a discussion of various topics to provide a proper foundation for understanding the present invention.

Cache memories are commonly used in the industry as a type of memory that holds readily available data to be fed into a processing node. It is usually thought of as the fastest, and hence most expensive, memory in a computer system. The main purpose of the cache memory is to provide data to the processing node such that the processing node does not have to wait to receive the data. The result is a system having a higher overall performance, mostly at the expense of additional costs, including additional power consumption. In some implementations, there are multiple cache levels that allow for a balance between cost and performance Therefore, a processing node may have a first level fast cache memory that is expensive but is kept relatively small and is supported by a slower but significantly larger second level cache memory.

Since the cache memory provides data at high rates to the processing node, it is imperative that it performs its task efficiently. In “read” operations, when a piece of data requested by the processing node is found in the cache, it is considered to be a “hit” and the data is immediately provided to the processing node. If the data is not located in the cache memory, it will have to locate the requested data from a slower memory. This will result in a delay in the supply of data to the processing node, which is referred to as a “miss.” The cache memory will generate a request for data, which is larger, in most cases, than the actual request received from the processing node. This is done due to a phenomenon called “spatial locality,” or in other words, the higher likelihood to use the data that is in the immediate vicinity of the requested data. In fact, advanced compilers take advantage of this capability and attempt to ensure a high as possible locality, which results in a higher system performance. In most cases the locality found in code is higher then the locality found in general data and therefore the “hit ratio”, i.e., the ratio between the number of hits and the total number of requests from the cache memory, is usually larger for code than for data.

Three commonly used types of cache memories are direct mapped caches, N-way set associative caches, and fully associative caches. In each of these caches, there is a basic unit known as the “cache line” which is filled up with data each time data that should be placed there is requested, but not found. The size of the cache line affects the performance of the system. The smaller the cache line, the more likely a miss will occur; however, using very large cache lines may result in a long latency, i.e., the time until data is returned in a case of miss, and inefficiency of the cache. Therefore, it is desirable to balance between these two opposite extremes. In all cases, the cache line, once determined, is fixed and does not change.

In a direct mapped cache memory, each memory location is mapped to a single cache line that it shares with many other addresses, but not all addresses. The hit ratio is relatively low and more suitable for storage of code that generally presents a high degree of locality and sequentially. An N-way set associative cache memory overcomes some of the deficiencies of the direct mapped cache memory by offering the possibility of mapping a memory location into N cache lines. Therefore, if one cache line is already in use, another one of the available cache lines may be used. Usually N is a power of 2 and therefore the association degree found may be 2, 4, 8 and so forth. In a full associative cache memory, each location in memory can be mapped into any one of the available lines of the cache. Theoretically, this implementation provides the highest hit rate but this comes at the expense of complexity and power consumption.

The fixed size cache line, as well as the single way of accessing the data, results in a relatively inflexible cache system. It would be advantageous to develop a system that allows for a variable size cache line as well as multiple ways of accessing data. It would also be advantageous to utilize the cache in distributed cache implementations.

### SUMMARY OF THE PRESENT INVENTION

The present invention has been made in view of the above circumstances and to overcome the above problems and limitations of the prior art.

Additional aspects and advantages of the present invention will be set forth in part in the description that follows and in part will be obvious from the description, or may be learned by practice of the present invention. The aspects and advantages of the present invention may be realized and attained by means of the instrumentalities and combinations particularly pointed out in the appended claims.

A first aspect of the invention provides a cache that stores a plurality of data blocks. The cache comprises a memory, and a skip-list based key handler that provides a cache address to the memory.

A second aspect of the present invention provides a skip-list based key handler. The skip-based key handler comprises data organized in a form of a skip list. The skip-based key handler further comprises means for searching the organized data and determining if an input address to the key handler matches an address contained within the key handler If it is determined that a match is found to the input address, the skip-based key handler further comprises means for outputting a cache address based on the matched input address.

A third aspect of the present invention provides a method for operating a skip-list based cache. The method comprises receiving an input address, and then determining if the input address is contained within a skip-list. Next, if the input address is contained within the skip-list, the method outputs a corresponding cache address. If the input address is not contained within the skip-list, a miss indication is issued. Next, if the cache address is available, the method accesses a memory and reads out the corresponding data.

A fourth aspect of the present invention provides a computer software product for a skip-list based cache. The computer software product comprises software instructions that enable the skip-list based cache to perform predetermined operations, and a computer readable medium that bears the software instructions. The predetermined operations comprise receiving an input address, and then determining if the input address is contained within a skip-list. Next, if the input address is contained within the skip-list, the predetermined operations output a corresponding cache address. If the input address is not contained within the skip-list, a miss indication is issued. Next, if the cache address is available, the predetermined operations access a memory and reads out the corresponding data.

The above aspects and advantages of the present invention will become apparent from the following detailed description and with reference to the accompanying drawing figures.

### BRIEF DESCRIPTION OF THE DRAWINGS

The accompanying drawings, which are incorporated in and constitute a part of this specification, illustrate the present invention and, together with the written description, serve to explain the aspects, advantages and principles of the present invention. In the drawings,

FIG. 1 is an exemplary block diagram of a skip-list based cache;

FIG. 2 is an exemplary flowchart of a skip-list based cache data read and update;

FIG. 3 is an exemplary mapping of variable size blocks from main memory to a memory of a skip-list based cache;

FIGS. 4A-4D illustrate an exemplary build of a single level skip-list as the result of the loading of data from main memory to a memory of a skip-list based cache; and

FIG. 5 is an exemplary mapping of a hierarchical skip-list for a skip-list based cache.

### DETAILED DESCRIPTION OF THE PRESENT INVENTION

Prior to describing the aspects of the present invention, some details concerning the prior art will be provided to facilitate the reader's understanding of the present invention and to set forth the meaning of various terms.

As used herein, the term “computer system” encompasses the widest possible meaning and includes, but is not limited to, standalone processors, networked processors, mainframe processors, and processors in a client/server relationship. The term “computer system” is to be understood to include at least a memory and a processor. In general, the memory will store, at one time or another, at least portions of executable program code, and the processor will execute one or more of the instructions included in that executable program code. The terms “block” or “data block” mean a consecutive area of memory containing data. Different blocks may have different size unless specifically determined otherwise.

As used herein, the terms “predetermined operations,” the term “computer system software” and the term “executable code” mean substantially the same thing for the purposes of this description. It is not necessary to the practice of this invention that the memory and the processor be physically located in the same place. That is to say, it is foreseen that the processor and the memory might be in different physical pieces of equipment or even in geographically distinct locations.

As used herein, the terms “media,” “medium” or “computer-readable media” include, but is not limited to, a diskette, a tape, a compact disc, an integrated circuit, a cartridge, a remote transmission via a communications circuit, or any other similar medium useable by computers. For example, to distribute computer system software, the supplier might provide a diskette or might transmit the instructions for performing predetermined operations in some form via satellite transmission, via a direct telephone link, or via the Internet.

Although computer system software might be “written on” a diskette, “stored in” an integrated circuit, or “carried over” a communications circuit, it will be appreciated that, for the purposes of this discussion, the computer usable medium will be referred to as “bearing” the instructions for performing predetermined operations. Thus, the term “bearing” is intended to encompass the above and all equivalent ways in which instructions for performing predetermined operations are associated with a computer usable medium.

Therefore, for the sake of simplicity, the term “program product” is hereafter used to refer to a computer-readable medium, as defined above, which bears instructions for performing predetermined operations in any form.

A detailed description of the aspects of the present invention will now be given referring to the accompanying drawings.

In traditional cache implementations, a key is used to access the data in the cache line. Specifically, the key is all or part of the address that is associated with the location in which the data resides. When data is requested, the address is compared with the relevant key, and if there is a match, then the data in the cache line may be used. Only the relevant data actually sought is provided from the cache. For example, if two bytes are needed out of a 16 byte cache line, the two bytes requested will appear as valid data from the cache.

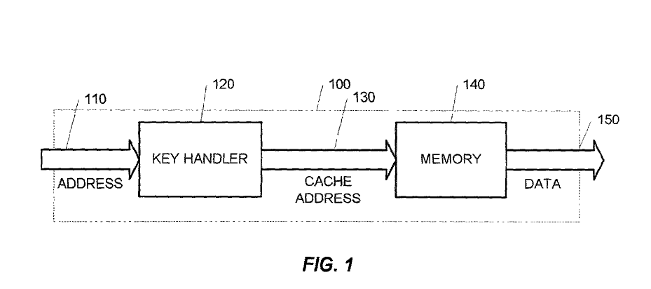

Referring to FIG. 1, an implementation of a skip list based cache memory 100 is shown. A key handler 120 receives an address 110 and by means of following through a skip list outputs a cache address 130. The cache address 130 is output if and only if the data requested in address 110 actually resides in cache 100. The cache address 130 is used to access memory 140 where the requested data is located, and the data is output on data bus 150. Key handler 120 may be implemented in software, hardware or combination thereof. While the implementation of key handler 120 would be possible with a single level skip-list implementation, it is beneficial to use a hierarchical skip-list implementation for a higher level of performance. A detailed explanation of skip lists is provided in “The Elegant (and Fast) Skip List” by Thomas Wegner, incorporated herein by reference for all it contains. A skilled artisan could easily modify cache address 130 implementation, such that the cache address is provided over network connectivity. Moreover, it would be possible to have several units of memory 140, and furthermore, such units of memory 140 could be geographically distributed resulting in a distributed cache implementation.

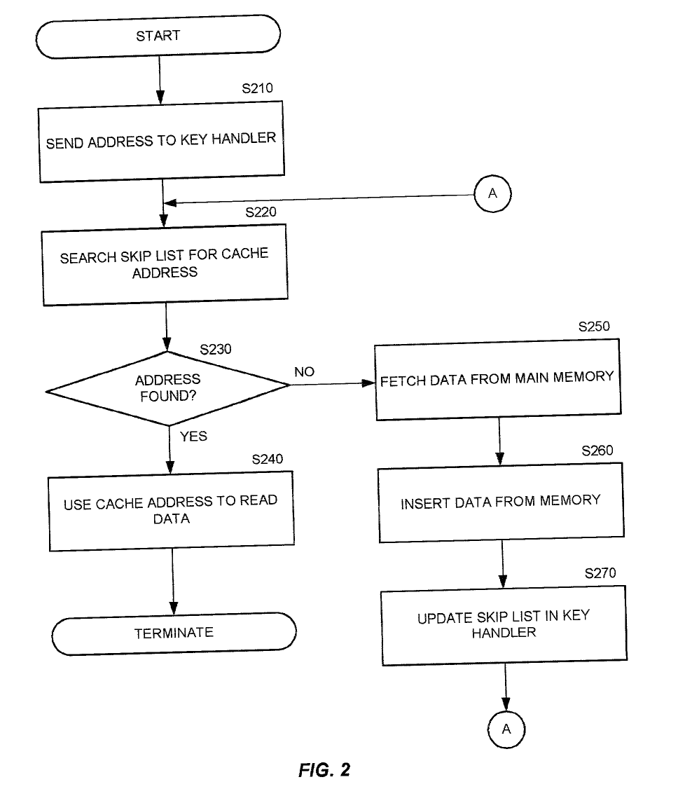

Referring to FIG. 2, where an exemplary flowchart 200 illustrating a search for a data in cache memory 100, and an update of cache 100 if such data is missing. At S210, an address 110 is provided to key handler 120. Address 110 is the system address in which a processing node expects the data to reside. At S220, key handler 220 searches the skip list to identify the position of address 110 and extract the cache address 130. If it is determined at S230 that the data may be found in memory 140, then execution continues at S240. At S240, the cache address is used to access memory 140 and the data is placed on the data bus 150 for use by the processing node. An example of the process is described below.

It is possible, however, that address 110 is not found by key handler 120 as the data was either never before placed in memory 140, or it is further possible that at a certain point in time the data did reside in the memory but was removed to provide space for other data. Regardless of the specific reason, if it is determined at S230 that the data is not in memory 140, the execution continues at S250 where data is fetched from main memory. A main memory of a processing node may be a larger and slower memory, such as a large dynamic random access memory (DRAM) array, a hard disk, or other types of slower memories. At S260, the data is inserted into memory 140 and at S270 the skip list of key handler 120 is updated. An example of the process is provided below. Execution continues at S220 with the purpose of providing the data to the processing node. A skilled artisan could easily adapt this process by first providing that data to the processing node and only then updating memory 140 and skip list of key handler 120.

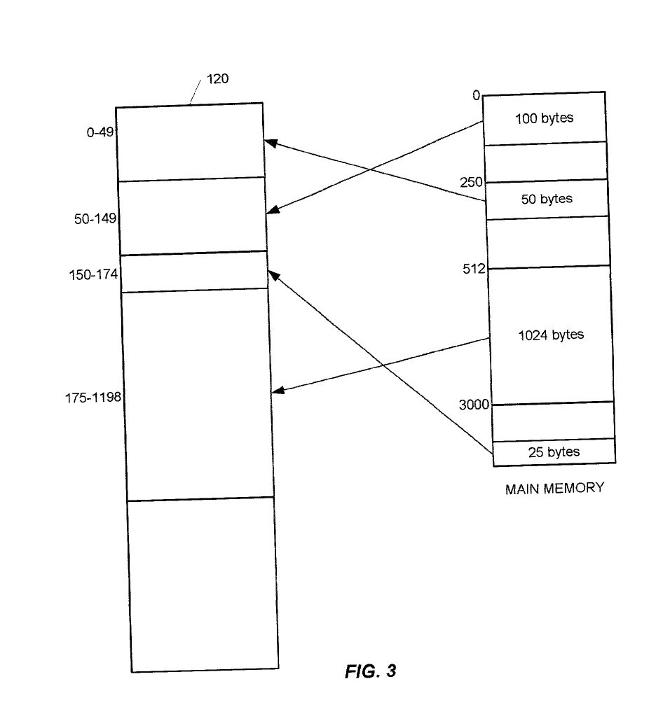

Referring to FIG. 3, a mapping of blocks of data residing in main memory into memory 120 of a skip-list based cache is shown. While main memory may be a significantly large memory, a cache memory, such as memory 120, is usually limited in size, but is mostly a fast memory to deliver high performance. In this case, first a 50 byte block, located at address “250” of main memory, is placed in address “0” of memory 120. The last byte of the 50 byte block is placed in address “49” of memory 120. Subsequently, a 100 byte block, beginning at address “0” of main memory, is mapped to address “50” of memory 120. Thereafter, a 25 byte block from address “3000” in main memory is placed starting at address “150” of memory 120 Finally, a 1.024 byte block, beginning at address “512” of main memory, is copied into memory 120 at location “175”. This sequence of events may take place as a processing node identifies these blocks of data to be required for its processing needs for a variety of possible operations such as read, write, modify, and others. Prior art cache architectures could not handle these kinds of significantly different and arbitrary sized blocks. In order to access these blocks efficiently, key handler 120 uses a skip list implementation.

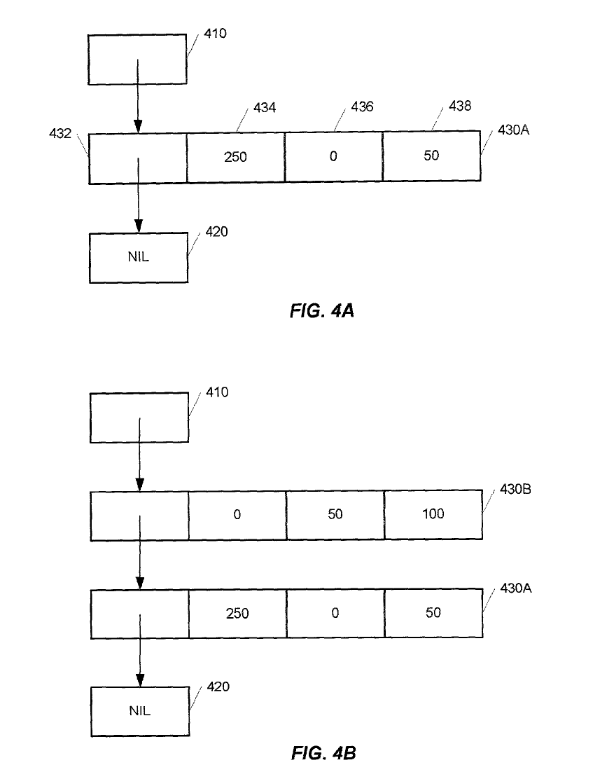

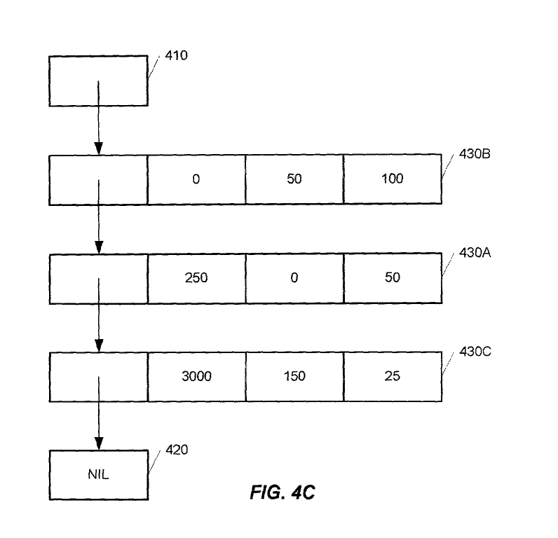

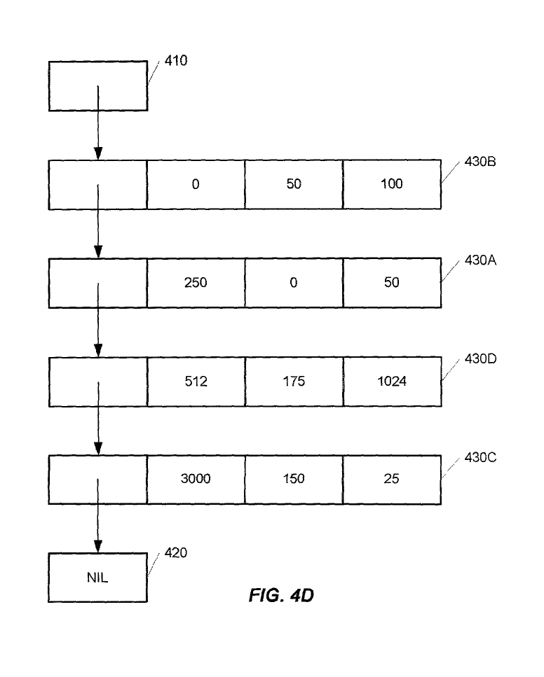

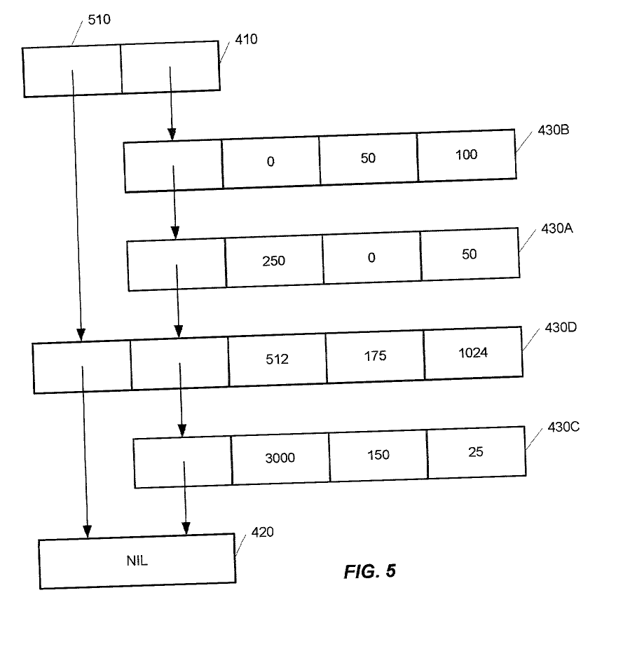

Referring to FIG. 4, the same sequence is shown as it applies to the creation of a single level skip list. In FIG. 4A, a skip list is shown after the first insertion of reference item 430A. It is inserted between the initial pointer 410 and the final skip-list node 420, otherwise referred to as the NIL of the skip list. Prior to insertion of reference items 430A, pointer 410 points to NIL 420, after the first insertion pointer 410 points to pointer 432 of reference item 430A and pointer 432 of reference items 430A points to NIL 420. Reference item 430A, in addition to the pointer 432 used to reference the next item, or in this example to NIL 430, has three more fields. Field 434, the memory block address (MBA) field, contains the address of the first item within a data block in main memory. Field 436, the cache block address (CBA) field, contains the address of the first item of the same block of data once placed in memory 120. Field 438, the block size field, contains the length of the block, for example, the length of the block in bytes, as presented in this example. The first block of data transferred to memory 120 is a 50 byte block, starting at address “250” of main memory. Being the first to be placed in memory 120, it is placed in address “0” of memory 120. This is indicated in the various fields of reference item 430A such that the MBA field 434 receives the value “250”, the CBA field 436 receives the value “0”, and the block size field 438 receives the value “50”.

In FIG. 4B, the next step of the transfer of data into skip-list based cache 100 is shown. The next data placed in memory 120 is a 100 byte block located in address “0” of the main memory. In a skip list implementation, the data item is placed between pointer 410 and reference item 430A, as is reference item 430B. The reason for that is that this would maintain the order in which the data blocks appear in main memory. MBA field 434 of reference item 430B receives therefore the value “0”, while CBA field 436 receives the value “50”, which is the address in memory 120 where the first byte of the block from the main memory will be place. Block size field 438 of reference item 430B receives the value “100” as 100 bytes are placed in memory 120. Similarly, the next reference items inserted are shown in FIGS. 4C and 4D for the 25 byte and 1024 byte blocks, respectively.

Turning now to locating data in a cache skip list, when a data byte from address “75” of main memory, supplied over address bus 110, is sought, key handler 120 is used to verify that such data exists in memory 120. If the data block exists in memory 120 the key handler 120 provides the cache address 130 that corresponds to the requested address 10. To perform this task, the skip list is checked and it is noted that reference item 430B has such data available as the address provided, i.e. address “75”, is within the address range of a block available in memory 120. The address range is determined to be the range spanning from an MBA 434 to the end of its corresponding data block determined by the block size 438. Hence, in this example the address range for the block referenced by reference item 430B spans from memory address “0” through memory address “99”, i.e., one hundred bytes, and therefore memory address “75” is within that range.

The cache address 130 is calculated based on the value contained in the CBA field 436 of reference item 430B, which is address “50” and adding to it item 430B. The reason for that is that this would maintain the order in which the data blocks appear in main memory. MBA field 434 of reference item 430B receives therefore the value “0”, while CBA field 436 receives the value “50”, which is the address in memory 120 where the first byte of the block from the main memory will be place. Block size field 438 of reference item 430B receives the value “100” as 100 bytes are placed in memory 120. Similarly, the next reference items inserted are shown in FIGS. 4C and 4D for the 25 byte and 1024 byte blocks, respectively.

Turning now to locating data in a cache skip list, when a data byte from address “75” of main memory, supplied over address bus 110, is sought, key handler 120 is used to verify that such data exists in memory 120. If the data block exists in memory 120 the key handler 120 provides the cache address 130 that corresponds to the requested address 110. To perform this task, the skip list is checked and it is noted that reference item 430B has such data available as the address provided, ie address “75”, is within the address range of a block available in memory 120. The address range is determined to be the range spanning from an MBA 434 to the end of its corresponding data block determined by the block size 438. Hence, in this example the address range for the block referenced by reference item 430B spans from memory address “0” through memory address “99”, i.e., one hundred bytes, and therefore memory address “75” is within that range.

The cache address 130 is calculated based on the value contained in the CBA field 436 of reference item 430B, which is address “50” and adding to it the offset of the memory address. The offset is calculated by subtracting from the memory address provided the corresponding MBA value. In this example the offset is calculated by subtracting the address “0” from the address “75” and hence the offset is “75”. The offset value is now added to the corresponding CBA value thereby adding “50” to the address. Therefore, the memory 120 is accessed using address “125”. The memory 120 will respond by providing the respective data on data bus 150. While this took only a single step of search in the skip list of key handler 120, it should be noted that the case would be different had address “3012” been used, i.e., the 13^{th} byte of the 25 byte block is to be provided. In this case, according to a single level implementation of a skip list, reference items 430B, 430A, 430D would have to be checked before finally arriving at reference item 430C where a “hit” would be found. This can become an even more demanding task when a significant number of blocks is present in memory 120.

Referring to FIG. 5, a hierarchical implementation 500 of a skip-list for a skip-list based cache is shown. For this purpose, an additional level of pointers is added. In this case, a pointer 510 is attached to the pointer 410. An additional pointer is added to a reference item that is several reference items ahead of the immediately next reference item. Hence, the pointer 410 points to the first level pointer of reference item 430B while the pointer 510 points to, in this example, to reference item 430D. Checking if an address is present in the skip-list based cache 100 is now done by first checking the higher level pointer of the skip list, i.e., the pointer 510. If the address in the pointed reference item is larger than the requested address, the lower level pointer is used and the search continues until a “hit” or “miss” are identified. If data in address “255” is sought, then initially the address in reference item 430D will be checked, as it is pointed to by pointer 510. As it contains the start memory address “512” it would mean that it is too high, as compared to the address being searched for and thus, the lower level pointer 410 should be used. The pointer 430 points to reference item 430B which does not contain the requested address and then the next reference item is used, namely reference item 430A, which does contain the requested data. The cache address is calculated and the data is then provided. However, if address “375” was sought, it would go through similar steps but the data is not found using reference item 430A and the next available reference item 430D has an address which is too large. This will result in a “miss” indication and a fetch procedure in order to insert the missing data block in memory 120. When address “3012” is searched, the pointer 510 is used first to access data item 430D which is still too small; however, the next position pointed to by pointer 510 is NIL. Therefore, it is necessary to use a lower level pointer of 430D, which points to reference item 430C, where the data is referenced. The advantage of the hierarchical approach is clear when a large number of blocks is used, as a faster search can be implemented. While a two level hierarchy was shown, a person skilled in the art could easily add additional levels as may be needed to implement an efficient search.

The foregoing description of the aspects of the present invention has been presented for purposes of illustration and description. It is not intended to be exhaustive or to limit the present invention to the precise form disclosed, and modifications and variations are possible in light of the above teachings or may be acquired from practice of the present invention. The principles of the present invention and its practical application were described in order to enable one skilled in the art to utilize the present invention in various embodiments and with various modifications as are suited to the particular use contemplated.

Thus, while only certain aspects of the present invention have been specifically described herein, it will be apparent that numerous modifications may be made thereto without departing from the spirit and scope of the present invention. Further, acronyms are used merely to enhance the readability of the specification and claims. It should be noted that these acronyms are not intended to lessen the generality of the terms used and they should not be construed to restrict the scope of the claims to the embodiments described therein.

What is claimed is:

1. A cache that stores a plurality of data blocks, said cache comprising:
a memory;
a skip-list based key handler that provides a cache address to said memory.

2. The cache as claimed in claim 1, wherein each data block in said plurality of data blocks can differ in size.

3. The cache as claimed in claim 1, wherein said memory comprises random access memory, flash memory, electrically erasable programmable read only memory or disk memory.

4. The cache as claimed in claim 1, wherein said key handler receives an address and determines whether or not data corresponding to the received address resides within said memory.

5. The cache as claimed in claim 4, wherein said key handler returns a miss indication if said data corresponding to the received address cannot be found in said memory.

6. The cache as claimed in claim 4, wherein said key handler returns a hit indication if said data corresponding to the received address can be found in said memory.

7. The cache as claimed in claim 6, wherein said key handler provides said cache address to said memory upon detection of said hit indication.

8. The cache as claimed in claim 7, wherein said memory returns said data corresponding to the received address in response to said cache address.

9. The cache as claimed in claim 1, wherein said skip-list has a single level.

10. The cache as claimed in claim 9, wherein said skip-list has at least one additional level.

11. The cache as claimed in claim 1, wherein said key handler is a semiconductor device.

12. The cache as claimed in claim 1, wherein said cache address is provided to said memory over an address bus.

13. The cache as claimed in claim 1, wherein said cache address is provided to said memory over a network.

14. The cache as claimed in claim 1, wherein said network is a local area network or a wide area network.

15. The cache as claimed in claim 13, wherein said memory is geographically distributed by partitioning of said memory.

16. The cache as claimed in claim 5, wherein of said memory of said cache is capable of being loaded with said data corresponding to the received address.

17. The cache as claimed in claim 16, wherein said skip-list is updated as a result of inserting said data corresponding to the received address in said memory.

18. A skip-list based key handler, said key handler comprising:
data organized in a form of a skip list;
means for searching said data and determining if a input address to said key handler matches an address contained within said key handler;
means for outputting a cache address if it is determined that a match is found to said input address.

19. The key handler as claimed in claim 18, wherein each row of said data has at least a start memory address, a start cache address and a data block size.

20. The key handler as claimed in claim 19, wherein said data block size is variable.

21. The key handler as claimed in claim 19, wherein said key handler compares between said input address and address ranges contained within said data.

22. The key handler as claimed in claim 21, wherein said address range is determined as a range beginning at said start memory address and the end of data block.

23. The key handler as claimed in claim 22, wherein said end of data block is determined by adding said start memory address to said data block size.

24. The key handler as claimed in claim 21, wherein said key handler issues a miss indication upon detection that said input address does not match any of said address ranges.

25. The key handler as claimed in claim 21, wherein said key handler issues a hit indication upon detection that said input address matches an address within an address range.

26. The key handler as claimed in claim 25, wherein said key handler issues said cache address extracted from said row indicated by said hit indication.

27. The key handler as claimed in claim 26, wherein said cache address is transferred over a memory address bus.

28. The key handler as claimed in claim 26, wherein said cache address is transferred over a network.

29. The key handler as claimed in claim 28, wherein said network is a local area network or a wide area network.

30. The key handler as claimed in claim 18, wherein said skip-list is a single level.

31. The key handler as claimed in claim 30 wherein said skip-list has at least one additional level.

32. The key handler as claimed in claim 24, wherein said skip-list is capable of being updated with a new row of data respective to a new data block inserted as a result of said miss.

33. A method for a skip-list based cache, said method comprising:
receiving an input address;
determining if said input address is contained within a skip-list;
if said input address is within said skip-list, outputting a corresponding cache address, or otherwise issuing a miss indication; and
if a cache address is available, accessing a memory and providing the corresponding data.

34. The method as claimed in claim 33, wherein said skip-list is a single level.

35. The method as claimed in claim 34, wherein said skip-list has at least one additional level.

36. The method as claimed in claim 33, wherein said skip-list is updated as a result of said miss indication.

37. The method as claimed in claim 36, wherein said method further comprises:
receiving information relative to a data block brought to said memory as a result of a miss indication;
storing said information in an appropriate location in said skip-list.

38. The method as claimed in claim 37, wherein said information comprises at least a memory block address of said data block, a cache block address and a data block size.

39. The method as claimed in claim 38, wherein said input address is determined to be within address ranges.

40. The method as claimed in claim 39, wherein said address range is determined by said memory block address and said data block size.

41. The method as claimed in claim 38, wherein said data block size is variable.

42. The method as claimed in claim 33, wherein said cache address is provided on a memory address bus.

43. The method as claimed in claim 33, wherein said cache address is provided over a network.

44. The method as claimed in claim 43, wherein said network is a local area network or a wide area network.

45. A computer software product for a skip-list based cache, wherein said computer software product comprises:
software instructions for enabling said skip-list based cache to perform predetermined operations, and a computer readable medium bearing the software instructions, said predetermined operations comprising:
receiving an input address;
determining if said input address is contained within a skip-list;
if said input address is within said skip-list, outputting a corresponding cache address, or otherwise issuing a miss indication;
if a cache address is available, accessing a memory and providing the corresponding data.

46. The computer software product as claimed in claim 45, wherein said skip-list is a single level.

47. The computer software product as claimed in claim 46, wherein said skip-list has at least one additional level.

48. The computer software product as claimed in claim 45, wherein said skip-list is updated as a result of said miss indication.

49. The computer software product as claimed in claim 48, wherein said method further comprises:
receiving information relative to a data block brought to said memory as a result of a miss indication; and
storing said information in an appropriate location in said skip-list.

50. The computer software product as claimed in claim 49, wherein said information comprises at least a memory block address, a cache block address and a data block size.

51. The computer software product as claimed in claim 50, wherein said input address is determined to be within an address ranges.

52. The computer software product as claimed in claim 51, wherein said address range begins with said memory block address and said data block size.

53. The computer software product as claimed in claim 50, wherein said data block size is variable.

54. The computer software product as claimed in claim 45, wherein said cache address is provided on a memory address bus.

55. The computer software product as claimed in claim 45, wherein said cache address is provided over a network.

56. The computer software product as claimed in claim 55, wherein said network is at a local area network or a wide area network.
